(19) United States
(12) Patent Application Publication
(10) Pub. No.: US 2025/0360805 A1
(43) Pub. Date: Nov. 27, 2025

(54) VEHICLE POWER SUPPLY SYSTEM

(71) Applicant: Yazaki Corporation, Tokyo (JP)

(72) Inventors: Hayato YAMAGUCHI, Shizuoka (JP); Sadaharu OKUDA, Shizuoka (JP)

(73) Assignee: Yazaki Corporation, Tokyo (JP)

(21) Appl. No.: 19/185,586

(22) Filed: Apr. 22, 2025

(30) Foreign Application Priority Data
May 21, 2024 (JP) 2024-082660

(51) Int. Cl. B60L 50/60

(52) U.S. Cl. CPC B60L 50/60; B60L 2210/10

(57) ABSTRACT

A vehicle power supply system includes a high-voltage battery mounted in a vehicle, a first DC/DC converter arranged on a front section side of the vehicle, a second DC/DC converter arranged on a rear section side in a longitudinal direction, a power supply line connecting the first DC/DC converter and the second DC/DC converter and supplied with both electric power transformed by the first DC/DC converter and electric power transformed by the second DC/DC converter, and a first power distributor, a second power distributor, and a third power distributor, each connecting the power supply line and a plurality of electric devices mounted in the vehicle, and distributing the electric power supplied from the power supply line to the electric devices.

### CROSS-REFERENCE TO RELATED APPLICATION(S)

The present application claims priority to and incorporates by reference the entire contents of Japanese Patent Application No. 2024-082660 filed in Japan on May 21, 2024.

### BACKGROUND OF THE INVENTION

### 1. Field of the Invention

The present invention relates to a vehicle power supply system.

### 2. Description of the Related Art

There is a vehicle power supply system including two DC/DC converters, two batteries, and two switching relays, arranged within a single vehicle (see, for example, JP 2020-029 200 A). In this vehicle power supply system, in a case where the output voltage supplied from one DC/DC converter is less than a predetermined value, turning the switching relay ON or OFF is controlled to compensate for the output voltage supplied from the other DC/DC converter, thus ensuring electric power supply to an in-vehicle electric device.

In a case where a conventional vehicle power supply system includes one battery and one DC/DC converter, a voltage value may decrease due to voltage drop as an in-vehicle electric device is arranged farther away from the DC/DC converter, leading a possibility that the voltage of the electric device is unstable. On the other hand, in a case where the vehicle power supply system includes two DC/DC converters, the voltage drop is controlled by these two DC/DC converters. However, the voltage may be unstable depending on the increase or decrease in load of the electric device, and there is room for improvement.

### SUMMARY OF THE INVENTION

An object of the present invention is to provide a vehicle power supply system capable of stabilizing a voltage to an in-vehicle electric device.

In order to achieve the above mentioned object, a vehicle power supply system according to one aspect of the present invention includes a power source that is mounted in a vehicle; a first converter that is arranged on one side of the vehicle in a longitudinal direction with respect to a center position of the longitudinal direction, and is configured to be able to transform DC power supplied from the power source; a second converter that is arranged on another side in the longitudinal direction with respect to the center position, and is configured to be able to transform the DC power; a power supply line that connects the first converter and the second converter, and is supplied with both electric power transformed by the first converter and electric power transformed by the second converter; and a plurality of power distributors, each connecting the power supply line and an electric device mounted in the vehicle, and distributing electric power supplied from the power supply line to the electric device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic structure of a vehicle power supply system according to a first embodiment;

FIG. 2 is a block diagram illustrating an operation example of the vehicle power supply system according to the first embodiment;

FIG. 3 is a block diagram illustrating an operation example of the vehicle power supply system according to the first embodiment in a case where loads of a plurality of electric devices arranged in a first vehicle region increase;

FIG. 4 is a block diagram illustrating an operation example of the vehicle power supply system according to the first embodiment in a case where the loads of the electric devices arranged in the first vehicle region and a second vehicle region increase;

FIG. 5 is a block diagram illustrating the flow of voltage information and current information between two DC/DC converters and three power distributors;

FIG. 6 is a table diagram illustrating pieces of the voltage information and current information obtained by the three power distributors and the control status of the output voltages of the two DC/DC converters.

FIG. 7 is a block diagram illustrating a schematic structure of a vehicle power supply system of a modification according to a second embodiment;

FIG. 8 is a block diagram illustrating, during a normal state, an operation example of the vehicle power supply system according to the modification of the second embodiment; and

FIG. 9 is a block diagram illustrating, during a short-circuit state, an operation example of the vehicle power supply system according to the modification of the second embodiment.

### DETAILED DESCRIPTION OF THE PREFERRED EMBODIMENTS

Hereinbelow, the embodiments of the present invention will be described in detail with reference to the drawings. The invention is not limited by the following embodiments. In other words, the components in the following embodiments include those that can be readily assumed by those skilled in the art or those that are substantially identical, and various omissions, substitutions, and modifications can be made without departing from the gist of the invention.

### First Embodiment

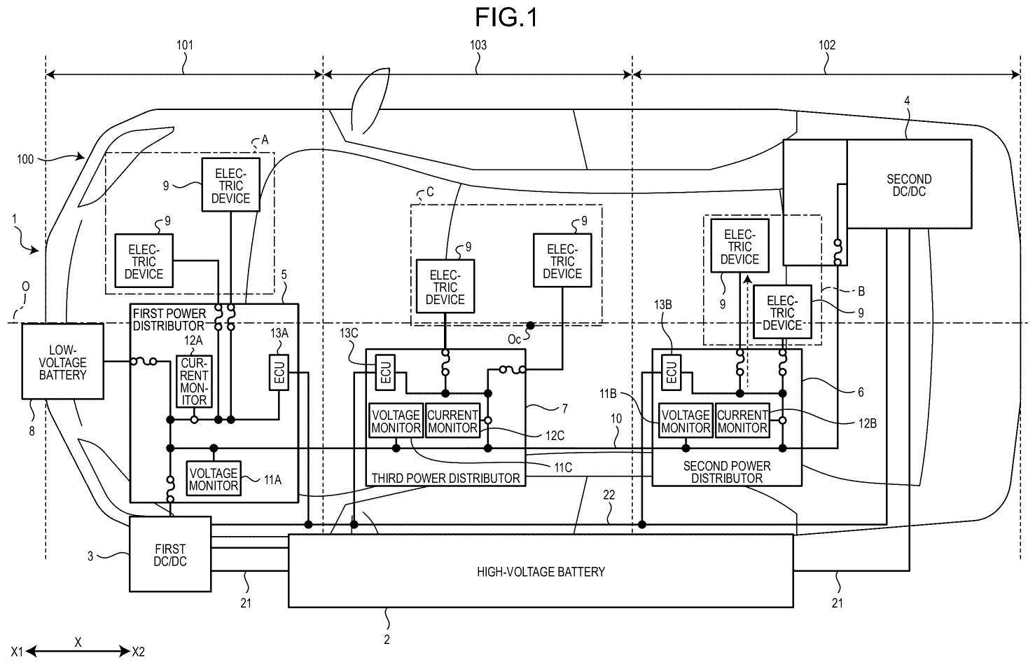

A vehicle power supply system 1 according to the present embodiment illustrated in FIGS. 1, 2, 3, and 4 is mounted in a vehicle 100, such as an electric vehicle (EV). The vehicle power supply system 1 includes a high-voltage battery 2, a first DC/DC converter 3, a second DC/DC converter 4, a first power distributor 5, a second power distributor 6, a third power distributor 7, a low-voltage battery 8, electric devices 9, and a power supply line 10, which are mounted in a vehicle 100.

In the following description, the X direction illustrated in the figure is referred to as a “longitudinal direction X” of the vehicle 100. This longitudinal direction X corresponds to, for example, a front-to-rear direction of the vehicle 100. Along the longitudinal direction X, the front side of the vehicle is designated as a “front section X1”, and the rear side is designated as a “rear section X2”.

The vehicle 100 includes a first vehicle region 101 positioned on the front section X1 side of the longitudinal direction X, a second vehicle region 102 positioned on the rear section X2 side of the longitudinal direction X, and a third vehicle region 103 positioned between the first vehicle region 101 and the second vehicle region 102 in the longitudinal direction X. In other words, the vehicle 100 is divided into the first vehicle region 101, the third vehicle region 103, and the second vehicle region 102 in this order along the longitudinal direction X, from the front section X1 side to the rear section X2 side.

In the vehicle power supply system 1 of the present embodiment, two DC/DC converters and three power distributors respectively arranged on the front section X1 and rear section X2 sides of the vehicle 100 are connected to a common power supply line 10, and a voltage monitor and a current monitor provided in each power distributor are used to change the output voltage of each DC/DC converter to stabilize the voltage.

The high-voltage battery 2 is mounted in the vehicle 100 and is a drive power source for driving the vehicle 100. The high-voltage battery 2 is a storage battery capable of storing relatively high-voltage DC power (hereinafter, simply referred to as “electric power”) as compared to the low-voltage battery 8, and can store electric power and discharge the electric power as required. The high-voltage battery 2 is individually connected to the first DC/DC converter 3 and the second DC/DC converter 4 via a high-voltage line 21. The high-voltage battery 2 is positioned, for example, between the first DC/DC converter 3 and the second DC/DC converter 4 in the longitudinal direction X of the vehicle.

Each of the first DC/DC converter 3 and the second DC/DC converter 4 is a DC transformer configured to transform electric power.

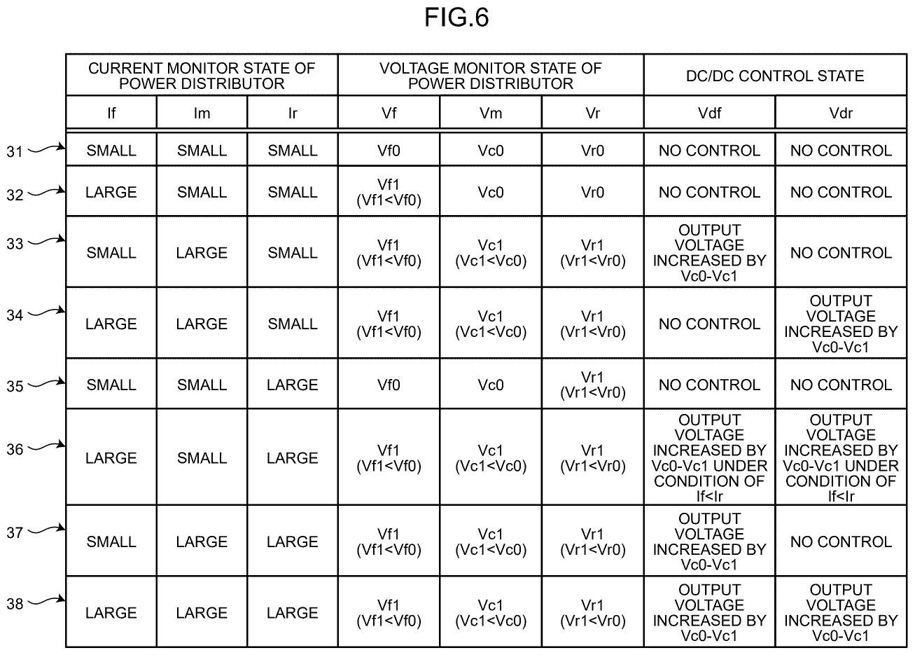

The first DC/DC converter 3 is positioned on one side (front section X1) of the vehicle 100 illustrated in FIG. 1 in the longitudinal direction X with respect to a center position Oc of the vehicle 100 in the longitudinal direction X. Specifically, the first DC/DC converter 3 is positioned in the first vehicle region 101 and boosts or steps down the DC voltage supplied from the high-voltage battery 2. The first DC/DC converter 3 is connected to the second DC/DC converter 4 via the power supply line 10 while being arranged in the first vehicle region 101. The first DC/DC converter 3 applies the transformed DC voltage to the power supply line 10 as an output voltage Vdf (see FIG. 6). The first DC/DC converter 3 is also connected to the second DC/DC converter 4 via a communication line 22. The first DC/DC converter 3 transforms the electric power supplied from the high-voltage battery 2 via a high-voltage line 21 to a predetermined output voltage and outputs the transformed voltage to the power supply line 10.

The second DC/DC converter 4 is positioned on the other side (rear section X2) in the longitudinal direction X with respect to the center position Oc. Specifically, the second DC/DC converter 4 is positioned in the second vehicle region 102 and boosts or steps down the DC voltage supplied from the high-voltage battery 2. The second DC/DC converter 4 is connected to the first DC/DC converter 3 via the power supply line 10 while being arranged in the second vehicle region 102. The second DC/DC converter 4 applies the transformed DC voltage to the power supply line 10 as an output voltage Vdr (see FIG. 6). The second DC/DC converter 4 transforms the electric power supplied from the high-voltage battery 2 via the high-voltage line 21 to a predetermined output voltage and outputs the transformed voltage to the power supply line 10.

Each of the first power distributor 5, the second power distributor 6, and the third power distributor 7 is, for example, an electric connection box. The electric connection box is a so-called relay box, junction box, or the like. The first power distributor 5, the second power distributor 6, and the third power distributor 7 are connected to each other via the power supply line 10.

The first power distributor 5 is arranged in the first vehicle region 101 and distributes electric power from the power supply line 10 to each of two electric devices 9 in the first vehicle region 101. Specifically, the first power distributor 5 is arranged on the front section X1 side of the vehicle 100 with respect to the center position Oc in the longitudinal direction X and includes a first voltage monitor 11A, a first current monitor 12A, and a first ECU 13A.

The first voltage monitor 11A is connected to the power supply line 10 and measures a voltage Vf of the electric power supplied from the power supply line 10 to the first power distributor 5.

The first current monitor 12A is connected to the power supply line 10 and the two electric devices 9 in the first vehicle region 101, and measures a current If supplied from the power supply line 10 to the two electric devices 9.

The first ECU 13A is connected to the power supply line 10, is supplied with electric power by the first DC/DC converter 3 via the power supply line 10, and is driven by the electric power. The first ECU 13A is connected to the first voltage monitor 11A and the first current monitor 12A and transmits the voltage Vf measured by the first voltage monitor 11A as voltage information to the first DC/DC converter 3 and the second DC/DC converter 4 via the communication line 22. The first ECU 13A also transmits the current If measured by the first current monitor 12A as current information to the first DC/DC converter 3 and the second DC/DC converter 4 via the communication line 22.

The second power distributor 6 is arranged in the second vehicle region 102 and distributes electric power from the power supply line 10 to each of two electric devices 9 in the second vehicle region 102. Specifically, the second power distributor 6 is arranged on the rear section X2 side of the vehicle 100 with respect to the center position Oc in the longitudinal direction X and includes a second voltage monitor 11B, a second current monitor 12B, and a second ECU 13B.

The second voltage monitor 11B is connected to the power supply line 10 and measures a voltage Vr of the electric power supplied from the power supply line 10 to the second power distributor 6.

The second current monitor 12B is connected to the power supply line 10 and the two electric devices 9 in the second vehicle region 102, and measures a current Ir supplied from the power supply line 10 to the two electric devices 9.

The second ECU 13B is connected to the power supply line 10, is supplied with electric power by the first DC/DC converter 3 via the power supply line 10, and is driven by the electric power. The second ECU 13B is connected to the second voltage monitor 11B and the second current monitor 12B and transmits the voltage Vr measured by the second voltage monitor 11B as voltage information to the first DC/DC converter 3 and the second DC/DC converter 4 via the communication line 22. The second ECU 13B also transmits the current Ir measured by the first current monitor 12A as current information to the first DC/DC converter 3 and the second DC/DC converter 4 via the communication line 22.

The third power distributor 7 is arranged in the third vehicle region 103 and distributes electric power from the power supply line 10 to each of two electric devices 9 in the third vehicle region 103. Specifically, the third power distributor 7 is arranged on the center position Oc of the vehicle 100 in the longitudinal direction X and includes a third voltage monitor 11C, a third current monitor 12C, and a third ECU 13C.

The third voltage monitor 11C is connected to the power supply line 10 and measures a voltage Vm of the electric power supplied from the power supply line 10 to the third power distributor 7.

The third current monitor 12C is connected to the power supply line 10 and the two electric devices 9 in the third vehicle region 103, and measures a current Im supplied from the power supply line 10 to the two electric devices 9.

The third ECU 13C is connected to the power supply line 10, is supplied with electric power by the first DC/DC converter 3 via the power supply line 10, and is driven by the electric power. The third ECU 13C is connected to the third voltage monitor 11C and the third current monitor 12C and transmits a voltage Vm measured by the third voltage monitor 11C as voltage information to the first DC/DC converter 3 and the second DC/DC converter 4 via the communication line 22. The third ECU 13C also transmits the current Im measured by the third current monitor 12C as current information to the first DC/DC converter 3 and the second DC/DC converter 4 via the communication line 22.

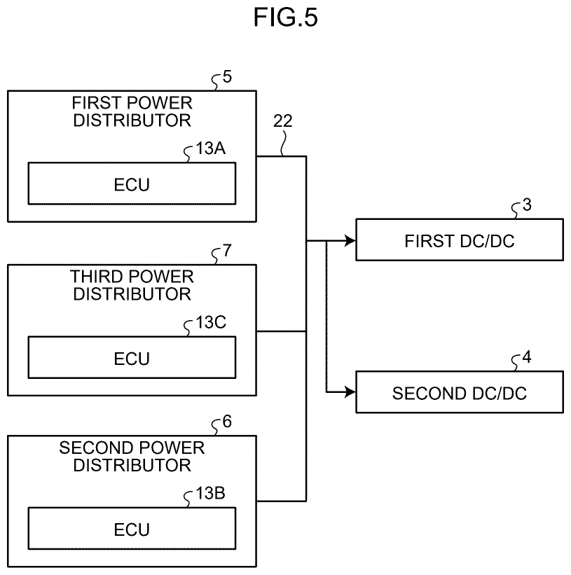

As illustrated in FIG. 5, in the vehicle power supply system 1 of the present embodiment, the first ECU 13A of the first power distributor 5, the second ECU 13B of the second power distributor 6, and the third ECU 13C of the third power distributor 7 are connected to each other via the communication line 22 between the first DC/DC converter 3 and the second DC/DC converter 4. Each of the first DC/DC converter 3 and the second DC/DC converter 4 controls output voltages based on the voltage information (Vf) and current information (If) received from the first ECU 13A of the first power distributor 5, the voltage information (Vr) and current information (Ir) received from the second ECU 13B of the second power distributor 6, and the voltage information (Vm) and current information (Im) received from the third ECU 13C of the third power distributor 7.

The low-voltage battery 8 is a storage battery that supplies relatively low-voltage power as compared to the high-voltage battery 2 and has a voltage of about 12 V, for example. The low-voltage battery 8 is connected to the power supply line 10 via a fuse F and connected to the first DC/DC converter 3 via the power supply line 10.

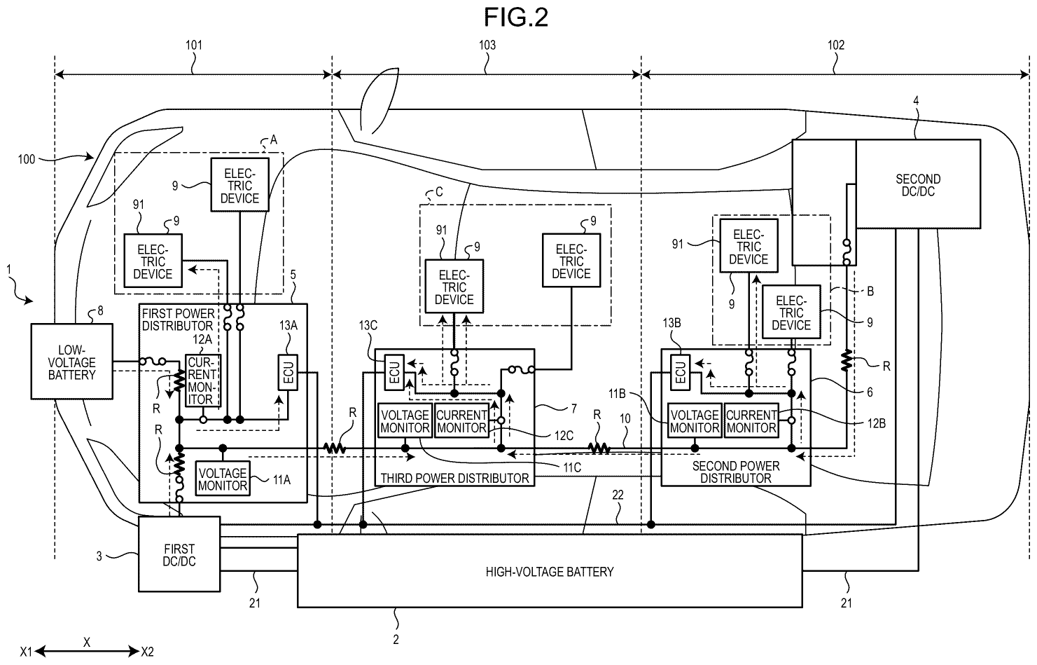

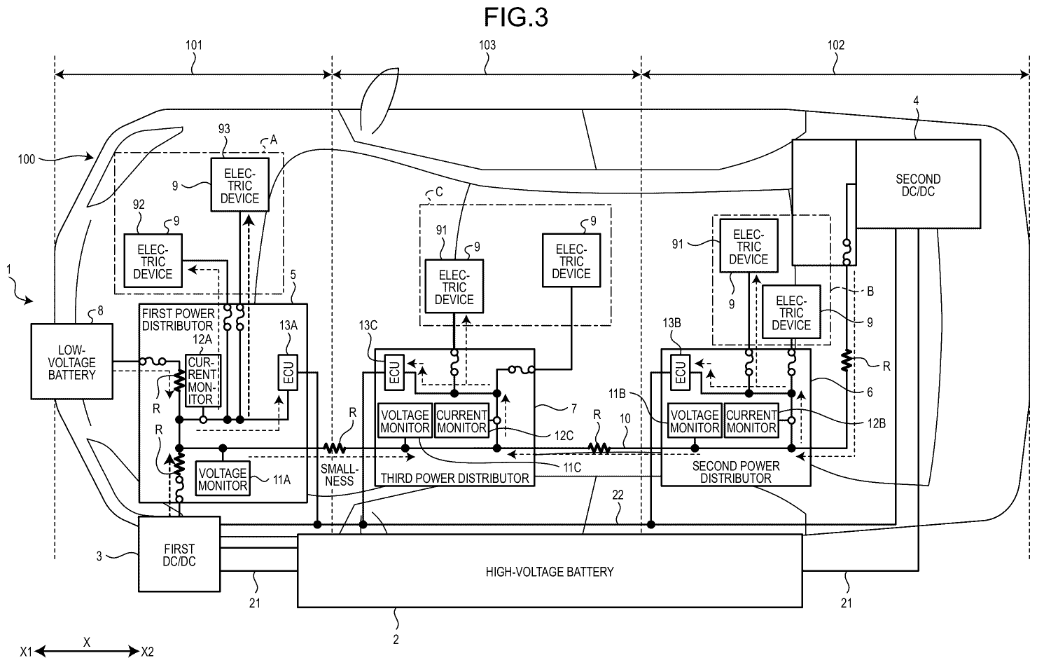

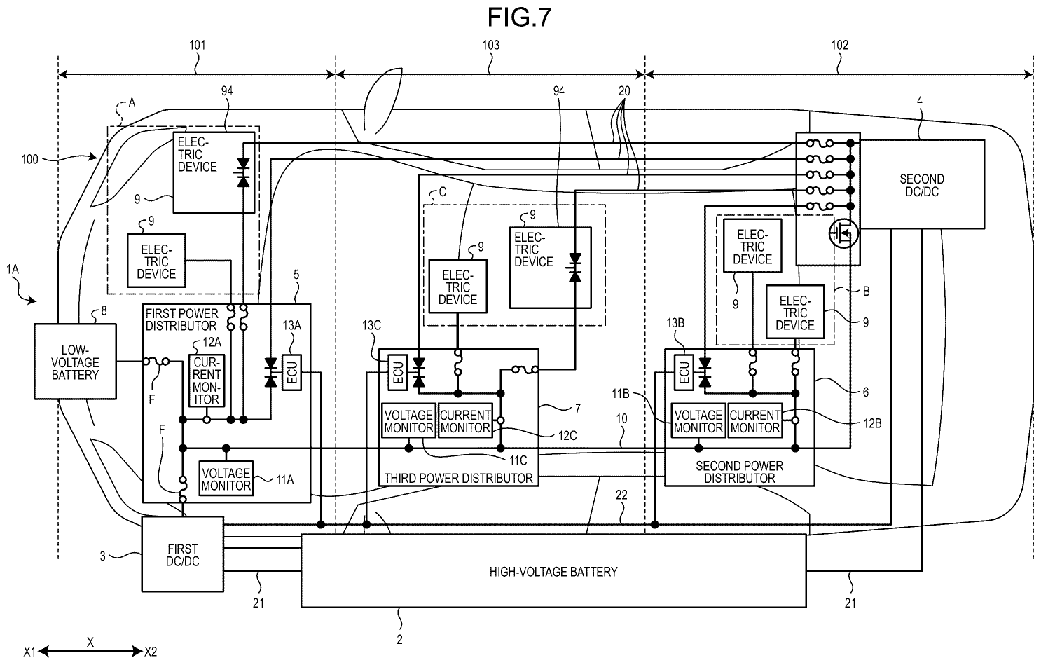

Each of the electric devices 9 is a load mounted in the vehicle 100 and driven by DC power. The electric devices 9 include, for example, an air conditioner, an audio device, and the like, as general loads, and a steering device, a braking device, sensors, and the like, as critical loads. A plurality of the electric devices 9 are positioned in each of the first vehicle region 101, the second vehicle region 102, and the third vehicle region 103. As illustrated in FIGS. 1 to 4 (including FIGS. 7 to 9), two electric devices 9 are arranged in the first vehicle region 101 of the present embodiment as a first device group A. In the second vehicle region 102, two electric devices 9 are arranged as a second device group B. In the third vehicle region 103, two electric devices 9 are arranged as a third device group C. The electric devices 9 includes, for example, an electric device 91 with a small load relative to the other electric devices 9, as illustrated in FIG. 2. The electric devices 9 also include, for example, an electric device 92 with a large load relative to the electric device 91 with a small load and an electric device 93 with a large load relative to the electric device 92, as illustrated in FIG. 3.

The electric devices 9 also include those that are always in the ON state and those that transition to either the ON state or the OFF state in a case where the vehicle is in the drive state (for example, ignition switch in the ON state). Therefore, each load of the first device group A, second device group B, and third device group C increases or decreases according to the ON/OFF state of each of the electric devices 9 and the load level of each of the electric devices 9.

The power supply line 10 connects the first DC/DC converter 3 and the second DC/DC converter 4, as described above, and is supplied with both electric power transformed by the first DC/DC converter 3 and electric power transformed by the second DC/DC converter 4. The power supply line 10 is routed across the first vehicle region 101, the third vehicle region 103, and the second vehicle region 102 along the longitudinal direction X from the front section X1 side to the rear section X2 side.

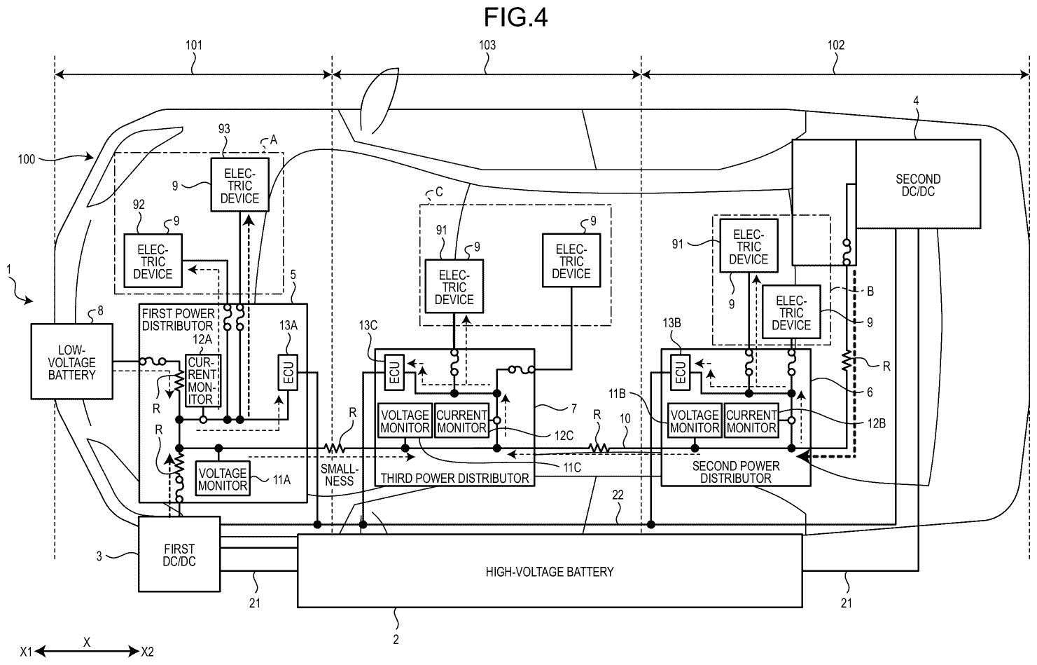

Next, an operation example of the vehicle power supply system 1 will be described with reference to FIGS. 2 to 4. The vehicle power supply system 1 illustrated in FIG. 2 is in a state where the loads of the first device group A to the third device group C are all relatively small. The vehicle power supply system 1 illustrated in FIG. 3 is in a state where the loads of the first device group A is relatively large as compared to those of the second device group B and the third device group C. The vehicle power supply system 1 illustrated in FIG. 4 is in a state where the load of the first device group A is relatively large as compared to those of the second device group B and the third device group C, and in a state where the load of the second device group B and the load of the third device group C increase as compared to those illustrated in FIG. 3.

In the vehicle power supply system 1 illustrated in FIG. 2, in each of the first device group A to the third device group C, one of the two electric devices 9 is in the ON state and the other is in the OFF state. The electric device 9 in the ON state is designated as the electric device 91. In a case where the loads of the first device group A to the third device group C are all relatively small, the currents If, Ir, and Im measured by the first current monitor 12A to the third current monitor 12C are all small, as illustrated in FIG. 6. In this case, assuming that the output voltage Vdf of the first DC/DC converter 3 and the output voltage Vdr of the second DC/DC converter 4 are the same, the voltages Vf, Vr, and Vm measured by the first voltage monitor 11A to the third voltage monitor 11C are dropped by resistors R of the power supply line 10, and the voltages Vf, Vr, and Vm measured by the first power distributor 5 to the third power distributor 7 is Vf0 (<Vdf), Vr0 (<Vdr), Vc0 (Vc0<Vf0, Vc0<Vr0) (state 31). It is assumed that Vf0, Vr0, and Vc0 are the target voltages.

In the vehicle power supply system 1 illustrated in FIG. 3, in the first device group A, both of the two electric devices 9 is in the ON state, and in each of the second device group B and the third device group C, one electric device 91 of the two electric devices 9 is in the ON state and the other is in the OFF state. As described above, in a case where the loads of the first device group A increase relative to the other device groups, the voltage drop of the first power distributor 5 due to the first device group A is relatively large. The electric power supplied to the third power distributor 7 from the first DC/DC converter 3 is thus slightly reduced, and the second DC/DC converter 4 compensates this reduced amount.

For example, as illustrated in FIG. 6, in a case where, among the currents If, Ir, and Im, only If is relatively larger than Ir and Im, the voltage Vf drops to Vf1, which is smaller than the target voltage Vf0 (Vf1<Vf0), the voltage Vr is the target voltage Vr0, and the voltage Vc is the target voltage Vc0, the first DC/DC converter 3 and the second DC/DC converter 4 do not control the output voltages Vdf and Vdr (state 32).

In a case where, among the currents If, Ir, and Im, only Im is relatively larger than If and Ir, the voltage Vf drops to Vf1, which is smaller than the target voltage Vf0 (Vf1<Vf0), the voltage Vm drops to Vcl, which is smaller than the target voltage Vc0 (Vc1<Vc0), and the voltage Vr drops to Vr1, which is smaller than the target voltage Vr0 (Vr1<Vr0), the second DC/DC converter 4 maintains the output voltage Vdr as is, and the first DC/DC converter 3 increases the output voltage Vdf (by Vc0−Vc1) (state 33).

In a case where, among the currents If, Ir, and Im, only Ir is relatively smaller than If and Im, the voltage Vf drops to Vf1 (Vf1<Vf0), the voltage Vm drops to Vc1 (Vc1<Vc0), and the voltage Vr drops to Vr1 (Vr1<Vr0), the first DC/DC converter 3 maintains the output voltage Vdf as is, and the second DC/DC converter 4 increases the output voltage Vdr (by Vc0−Vc1) (state 34).

Furthermore, in a case where, among the currents If, Ir, and Im, only Ir is relatively larger than If and Im, the voltage Vf is Vf0, the voltage Vm is Vc0, and the voltage Vr drops to Vr1 (Vr1<Vr0), the first DC/DC converter 3 and the second DC/DC converter 4 do not control the output voltage Vdf and Vdr (state 35).

In a case where, among the currents If, Ir, and Im, only Im is relatively smaller than If and Ir, and the voltage Vf drops to Vf1 (Vf1<Vf0), the voltage Vm drops to Vc1 (Vc1<Vc0), the voltage Vr drops to Vr1 (V1<Vr0), and the current If is under the condition of If<Ir, the first DC/DC converter 3 increases the output voltage Vdf (by Vc0−Vc1, and the second DC/DC converter 4 increases the output voltage Vdf (by Vc0−Vc1) (state 36).

On the other hand, in a case where, among the currents If, Ir, and Im, only If is relatively smaller than Im and Ir, the voltage Vf drops to Vf1 (Vf1<Vf0), the voltage Vm drops to Vc1(Vc1<Vc0), and the voltage Vr drops to Vr1 (Vr1<Vr0), the second DC/DC converter 4 maintains the output voltage Vdr as is, and the first DC/DC converter 3 increases the output voltage Vdf (by Vc0−Vc1) (state 37).

In a case where the currents If, Ir, and Im all are relatively large, the voltage Vf drops to Vf1 (Vf1<Vf0), the voltage Vm drops to Vc1 (Vc1−Vc0), and the voltage Vr drops to Vr1 (Vr1<Vr0), the first DC/DC converter 3 increases the output voltage Vdf (by Vc0−Vc1), and the second DC/DC converter 4 increases the output voltage Vdf (by Vc0−Vc1) (state 38).

As described above, the vehicle power supply system 1 according to the present embodiment includes: the high-voltage battery 2 mounted in the vehicle 100; the first DC/DC converter 3 arranged on the front section X1 side of the vehicle 100 and configured to be able to transform DC power supplied from the high-voltage battery 2; the second DC/DC converter 4 arranged on the rear section X2 side in the longitudinal direction X and configured to be able to transform DC power; the power supply line 10 connecting the first DC/DC converter 3 and the second DC/DC converter 4 and supplied with both electric power transformed by the first DC/DC converter 3 and electric power transformed by the second DC/DC converter 4; and the first power distributor 5, the second power distributor 6, and the third power distributor 7, each connecting the power supply line 10 and a plurality of the electric devices 9 mounted in the vehicle 100, and distributing the electric power supplied from the power supply line 10 to a plurality of the electric devices 9.

As described above, the vehicle power supply system 1 can stabilize the voltage by controlling the electric power supplied from the first DC/DC converter 3 and the second DC/DC converter 4 to the power supply line 10.

In addition, in the vehicle power supply system 1, the first power distributor 5 includes the first voltage monitor 11A that measures the voltage Vf of the electric power supplied from the power supply line 10 to the first power distributor 5 as voltage information and the first current monitor 12A that measures the current If supplied from the power supply line 10 to the two electric devices 9 as current information.

The second power distributor 6 includes the second voltage monitor 11B that measures the voltage Vr of the electric power supplied from the power supply line 10 to the second power distributor 6 as voltage information and the second current monitor 12B that measures the current Ir supplied from the power supply line 10 to the two electric devices 9 as current information.

The third power distributor 7 includes the third voltage monitor 11C that measures the voltage Vm of the electric power supplied from the power supply line 10 to the third power distributor 7 as voltage information and the third current monitor 12C that measures the current Im supplied from the power supply line 10 to the two electric devices 9 as current information.

Each of the first DC/DC converter 3 and the second DC/DC converter 4 controls the output voltages Vdf and Vdr based on a plurality of pieces of the voltage information (Vf, Vr, and Vm) and a plurality of pieces of the current information (If, Ir, and Im) received from the first power distributor 5, the second power distributor 6, and the third power distributor 7.

As described above, the vehicle power supply system 1 can control the output voltages of the first DC/DC converter 3 and the second DC/DC converter 42 based on the voltage information and the current information received from the three power distributors connected to the power supply line 10, thus enabling voltage stabilization.

### Second Embodiment

Next, a vehicle power supply system 1A according to a second embodiment illustrated in FIGS. 7, 8, and 9 will be described. The vehicle power supply system 1A differs from the above vehicle power supply system 1 in that a second DC/DC converter 4 is individually connected to a first power distributor 5, a second power distributor 6, a third power distributor 7, and some of the electric devices 9, via a sub-power supply line 20 different from a power supply line 10. In the second embodiment, the same numerical references are designated to the same components as in the first embodiment described above, and the redundant detailed descriptions thereof are omitted.

The vehicle power supply system 1A includes five sub-power supply lines 20 that differ from the power supply line 10. The five sub-power supply lines 20 are connected to the second DC/DC converter 4 via fuses on one side and to the first power distributor 5, the second power distributor 6, the third power distributor 7, and the two electric devices 9, respectively on the other side via forward diodes.

The second DC/DC converter 4 is connected to a first ECU 13A of the first power distributor 5 via one of the sub-power supply lines 20 and supplies electric power to the first ECU 13A. The second DC/DC converter 4 is connected to a second ECU 13B of the second power distributor 6 via one of the sub-power supply lines 20 and supplies electric power to the second ECU 13B. The second DC/DC converter 4 is connected to a third ECU 13C of the third power distributor 7 via one of the sub-power supply lines 20 and supplies electric power to the third ECU 13C. In other words, the first ECU 13A, the second ECU 13B, and the third ECU 13C in the second embodiment are all supplied with electric power from both the first DC/DC converter 3 and second DC/DC converter 4, and are driven by the electric power.

In each of a first vehicle region 101 and a third vehicle region 103 of the present embodiment, two electric devices 9 are arranged, and one of the two electric devices 9 is a general load (air conditioner, audio device, or the like) and the other is a critical load (steering device, brake device, sensors, or the like). Electric devices 94 of the present embodiment are critical loads. All of the electric devices 94 are connected to the power supply line 10 and the sub-power supply line 20. In other words, the electric devices 94 are all supplied with electric power from both the first DC/DC converter 3 and second DC/DC converter 4, and are driven by the electric power.

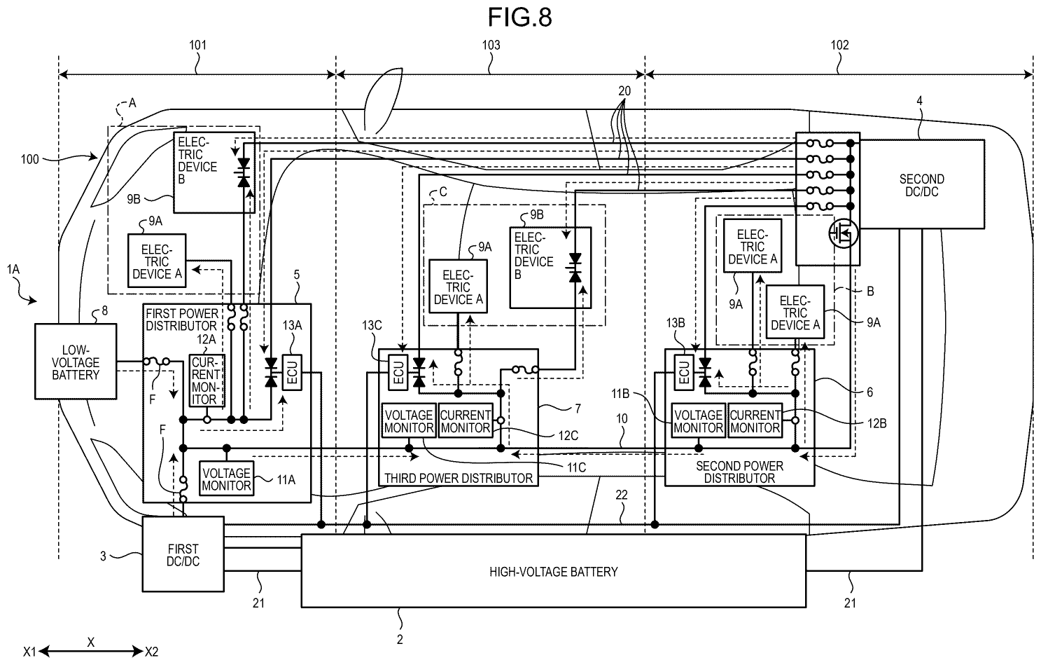

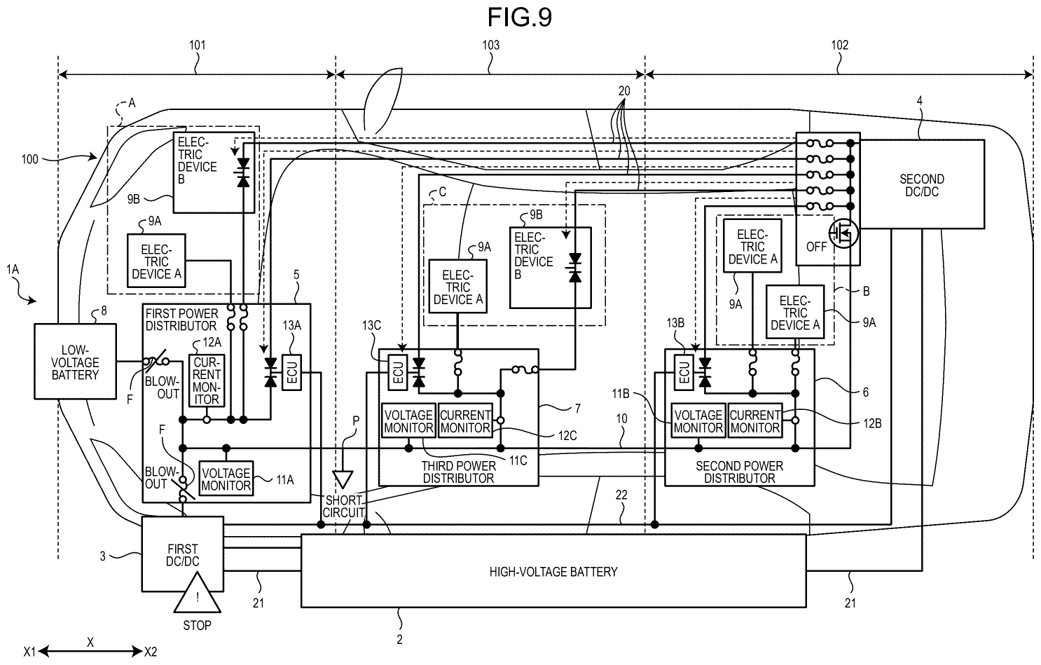

Next, an operation example of the vehicle power supply system 1A will be described with reference to FIGS. 8 and 9. The vehicle power supply system 1A illustrated in FIG. 8 is in its normal state. The vehicle power supply system 1A illustrated in FIG. 9 is in a state where the fuse F between the low-voltage battery 8 and the power supply line 10 has been blown due to a short-circuit in the power supply line 10, and a fuse F between the low-voltage battery 8 and the first DC/DC converter 3 has also been blown.

In the vehicle power supply system 1A illustrated in FIG. 8, in the normal state, electric power is supplied to each of the first ECU 13A, the second ECU 13B, the third ECU 13C, and the two electric devices 9B from both the first DC/DC converter 3 and the second DC/DC converter 4 via the power supply line 10 and the sub-power supply lines 20. For example, as illustrated in FIG. 9, in a case where the power supply line 10 has undergone a short-circuit (for example, grounding or the like) at a point P between the first power distributor 5 and the third power distributor 7, in order to protect electric device 9, the fuse F between the low-voltage battery 8 and the power supply line 10, and the fuse F between the first DC/DC converter 3 and the power supply line 10 blows due to overcurrent. In this case, the first DC/DC converter 3 stops supplying electric power to the first power distributor 5, the second power distributor 6, the third power distributor 7, and the six electric devices 9. On the other hand, the second DC/DC converter 4 continues to supply electric power to each of the first ECU 13A, the second ECU 13B, the third ECU 13C, and every two electric devices 9B. These first ECU 13A, second ECU 13B, third ECU 13C, and the two electric devices 9B can continue to be driven by the power supply from the second DC/DC converter 4 even though the power supply from the first DC/DC converter 3 stops.

As described above, in the vehicle power supply system 1A according to the present embodiment, the second DC/DC converter 4 is connected to the first power distributor 5, the second power distributor 6, the third power distributor 7, and the two electric devices 9B by the sub-power supply lines 20 different from the power supply line 10, and electric power is supplied, via the sub-power supply lines 20, to the power distributors ECU and the electric devices 9B, which are the critical loads. Therefore, in the vehicle power supply system 1A, for example, even though a short-circuit or the like occurs in the power supply line 10 and the power supply from the first DC/DC converter 3 stops, the second DC/DC converter 4 can continue to supply electric power to the power distributors ECU and the critical loads. As a result, it is possible to achieve redundancy implementation in the vehicle power supply system 1A.

In the first and second embodiments described above, the power supply line 10 is routed in a straight line along the longitudinal direction X with respect to the vehicle 100, but the present invention is not limited to this configuration.

In the first and second embodiments described above, the vehicle 100 is divided into three vehicle regions of the first vehicle region 101, the third vehicle region 103, and the second vehicle region 102, but the present invention is not limited to this configuration.

In the first and second embodiments described above, the two electric devices 9 are arranged in each of the first vehicle region 101, the second vehicle region 102, and the third vehicle region 103, but the present invention is not limited to this configuration.

According to the vehicle power supply system of the present embodiment, it is possible to provide the effect of stabilizing the voltage to the in-vehicle electric device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle power supply system comprising:
a power source that is mounted in a vehicle;
a first converter that is arranged on one side of the vehicle in a longitudinal direction with respect to a center position of the longitudinal direction, and is configured to be able to transform DC power supplied from the power source;
a second converter that is arranged on another side in the longitudinal direction with respect to the center position, and is configured to be able to transform the DC power;
a power supply line that connects the first converter and the second converter, and is supplied with both electric power transformed by the first converter and electric power transformed by the second converter; and
a plurality of power distributors, each connecting the power supply line and an electric device mounted in the vehicle, and distributing electric power supplied from the power supply line to the electric device.

2. The vehicle power supply system according to claim 1, wherein
the power distributors include
voltage monitors measuring voltages of the electric power supplied from the power supply line to the power distributors, as pieces of voltage information, and
current monitors measuring currents supplied from the power supply line to a plurality of the electric devices, as pieces of current information, and
each of the first converter and the second converter controls output voltages based on a plurality of the pieces of voltage information and a plurality of the pieces of current information received from a plurality of the power distributors.

3. The vehicle power supply system according to claim 2, wherein
the vehicle includes a first vehicle region positioned on one side in the longitudinal direction, a second vehicle region positioned on another side in the longitudinal direction, and a third vehicle region positioned between the first vehicle region and the second vehicle region in the longitudinal direction,
the first converter
is provided in the first vehicle region,
the second converter
is provided in the second vehicle region,
a plurality of the power distributors include:
a first power distributor that is provided in the first vehicle region and distributes the electric power supplied from the power supply line to a plurality of the electric devices corresponding to the first vehicle region among a plurality of the electric devices;
a second power distributor that is provided in the second vehicle region and distributes the electric power supplied from the power supply line to a plurality of the electric devices corresponding to the second vehicle region among a plurality of the electric devices; and
a third power distributor that is provided in the third vehicle region and distributes the electric power supplied from the power supply line to a plurality of the electric devices corresponding to the third vehicle region among a plurality of the electric devices,
at least the third power distributor is capable of distributing the electric power supplied to the power supply line from both the first converter and the second converter to a plurality of the electric devices corresponding to the third vehicle region, and
each of the first converter and the second converter
controls the output voltages based on the voltage information and the current information received from the first power distributor, the voltage information and the current information received from the second power distributor, and the voltage information and the current information received from the third power distributor.

4. The vehicle power supply system according to claim 1, wherein
the second converter
is connected to a plurality of the power distributors and a plurality of the electric devices via sub-power supply lines different from the power supply line, and supplies the electric power to some of the power distributors and some of the electric devices via the sub-power supply lines.

5. The vehicle power supply system according to claim 2, wherein
the second converter
is connected to a plurality of the power distributors and a plurality of the electric devices via sub-power supply lines different from the power supply line, and supplies the electric power to some of the power distributors and some of the electric devices via the sub-power supply lines.

6. The vehicle power supply system according to claim 3, wherein
the second converter
is connected to a plurality of the power distributors and a plurality of the electric devices via sub-power supply lines different from the power supply line, and supplies the electric power to some of the power distributors and some of the electric devices via the sub-power supply lines.
